(19) United States
(12) Patent Application Publication
(10) Pub. No.: US 2021/0387191 A1
(43) Pub. Date: Dec. 16, 2021

(54) Fluid refining device

(71) Applicant: Trilobite Innovation AS, KRISTIANSAND (NO)

(72) Inventor: Eirik Bentzen Egeland, KRISTIANSAND (NO)

(21) Appl. No.: 17/286,492

(22) PCT Filed: Oct. 23, 2019
(86) PCT No.: PCT/EP2019/078874

§ 371 Date: Apr. 19, 2021

Related U.S. Application Data
(60) Provisional application No. 62/749,464, filed on Oct. 23, 2018.

(51) Int. Cl. B01L 3/00

(52) U.S. Cl. CPC B01L 3/502746; G01N 15/0255; B01L 3/502761

(57) ABSTRACT

A fluid refining device comprises at least two obstructions adapted to be facing with a front in an upstream direction towards an incoming fluid and a base edge opposite of the front, and a fluid outlet arranged at the base edge.

### FIELD OF THE INVENTION

The present invention relates to a fluid refining device and unit, in particular to a device which is compatible with microfabrication technologies, and can be applied in the fields of microfluidics and other related technologies, as well as being able to operate with larger volumes.

### BACKGROUND

The field of microfluidics is concerned with the behaviour, control and manipulation of fluids that are geometrically constrained to a small, typically sub-millimetre, dimension, and more typically with volumes of fluid in the millilitre scale, microlitre scale, nanolitre scale or even smaller. Common processing manipulations that one may wish to apply to fluids at all scales include concentrating, separating, mixing and reaction processes.

Over the last few decades miniaturisation technologies have progressed which, in the chemical and biotechnology fields in particular, has resulted in the emergence of lab-on-a-chip devices which are now in common use. For example, micro-chemical devices and microelectromechanical systems (MEMS) such as bio-MEMS devices are known.

However, it is not always feasible to directly miniaturize conventional fluid processing systems designed for relatively large volumes of fluids for use in the microfluidic field where the system would be typically provided on a chip as a lab-on-a-chip device. Take the centrifugation process as an example: the centrifugation process involves a circular plate and comprises complex mechanical and electrical systems, which are only readily applicable for processing relatively large volumes of fluids in at least several tens of milliliter scale. For microfluidics where the volumes of fluid are typically in the micro- or nano-litre scale, such a device would be uneconomical. It would also be extremely difficult from a physical engineering perspective to miniaturize the conventional centrifugation systems on to a chip scale device directly.

The concentration and separation of samples are indispensable for clinical assay and biomedical analysis. The demand for cell fractionating and isolating for such applications has increased for molecular diagnosis, cancer therapy, and biotechnology applications within the last two decades. Consequently, alternative systems for concentration/separation of small/micro volumes of fluids, which involve different mechanisms, have been developed. Among these systems, some utilize the mechanical principles, such as force, geometry, etc.; and others utilize multi physics coupling method, such as magnetic field, electric field, optics, etc.

For concentration purpose, by utilizing differences in cell size, shape and density, various membrane structures microconcentrators have been developed, such as ultrafiltration membranes or nanoporous membranes formed by using ion track-etching technology for separating fluid components. See for example, R. V. Levy, M. W. Jornitz. Types of Filtration. Adv. Biochem. Engin./Biotechnol., vol. 98, 2006, pp. 1-26. and S Metz, C Trautmann, A Bertsch and Ph Renaud. Polyimide microfluidic devices with integrated nanoporous filtration areas manufactured by micromachining and ion track technology. Journal of Micromechanics and Microengineering, 2004, 14: 8. Even more, a MEMS filter modules with multiple films (membranes) has been invented, see: Rodgers et al, MEMS Filter Module, US 2005/0184003A1.

However, due to the presence of “dead-ends” in such membranes (films), clogging is common for microfilters with such flat membrane structures and would be even much more severe in those with multiple films. Moreover, microfilters with flat membrane structures require specialised fabrication processes, which results in difficulties in integrating such thin functional membranes into a lab-on-chip system.

To eliminate the dead-ends in membrane filters, the so-called “cross-flow” filters were developed, see for examples: Foster et al., Microfabricated cross flow filter and method of manufacture, US2006/0266692A1 and Iida et al., Separating device, analysis system, separation method and method for manufacture of separating device, EP1457251A1. In their inventions, the filtrate barriers are often made with arbitrary shapes, with simple geometrical profiles, i.e., square, trapezoid, and even crescent. These non-streamline profiles of the barriers will cause extra flow resistance, which reduces the filtrate efficiency. Moreover, due to the presence of square corners or cusps in such arbitrary geometrical profiles, clogging is apt to occur in practical use since the target cells or particles may have considerable deformability and adhesiveness.

GB 2472506 describes a counterflow-based filtrating unit and fluid processing device which can be applied in the fields of microfluidics and other related technologies. The filtration unit comprises turbine blade-like barrier elements that can reduce the flow resistance of the filtrate flow and also create a smoothly continuous flow field around them, thus to improve filtrating efficiency and reduce risks of clogging. There are no square corners or cusps within the streamlined turbine blade-like barrier elements, which can be applicable to various cells with different shapes. With its bigger end extending deeply into the main flow, the streamlined turbine blade-like barrier element can function as a flow guider for the cells above the desired size.

There is a need for a fluid refining unit and device which improves prior art for example by increasing non-clogging capability and simplify the production process.

In the context of this description, the term “refining” will mean all types of fluid processing, such as sorting, separation, concentration, or filtration of fluids comprising particles, multi phase fluids, or other fluids.

The object of the invention is to provide a unit and device which can concentrate and separate cells and particles with increased precision for classification, enrichment and analysis by using a special microfluidic geometry and tunable flow fields. To avoid clogging, there are no filter pores or size channels. Interactions between cells and particles with tunable flow fields and obstructions are utilized for precise separation and concentration.

The object of the invention is achieved by means of the patent claims.

In one embodiment a fluid refining device comprises at least two obstructions adapted to be facing with a front in an upstream direction towards an incoming fluid and a base edge opposite of the front, and a fluid outlet arranged at the base edge.

The fluid refining device may further comprise a feed fluid inlet, filtrate outlets, and a concentrate outlet for collection of large particles and cells from fluid having passed through the device.

In one embodiment, the obstructions are triangularly shaped heads, and the heads are adapted to be arranged with a front vertex facing the upstream direction and the base edge is the edge of the triangular shape which is opposite of the front vertex.

The obstructions may alternatively be bell shaped.

In one embodiment, the fluid refining device further comprises a barrier section facing in a downstream direction, the barrier section comprising a series of barrier elements and interposed gaps, where the barrier elements have a turbine blade-like shape and the interposed gaps define barrier channels providing fluid communication between the incoming fluid and the fluid outlet. The barrier section may be arranged adjacent to the obstructions downstream of the obstructions.

In one embodiment the fluid refining device comprises pressure sensors, for example arranged at the fluid inlet and/or the fluid outlet and/or other locations along the fluid flow path for measuring the fluid pressure. There may also be arranged pressure control devices at the fluid inlet and/or the fluid outlet. The fluid refining device may further comprise or be connected to a processor adapted to control the fluid pressure at the inlet and/or the outlet and/or at the locations of the obstructions. Control of the pressure enables better uniformity over the fluid refining device, thus preventing clogging.

The invention will now be described in more detail, by means of example and by reference to the accompanying drawings.

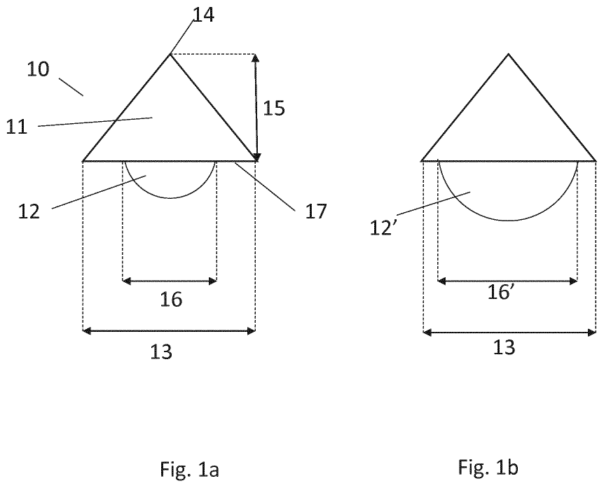

FIG. 1 illustrates an example of an obstruction for use in a fluid refining device.

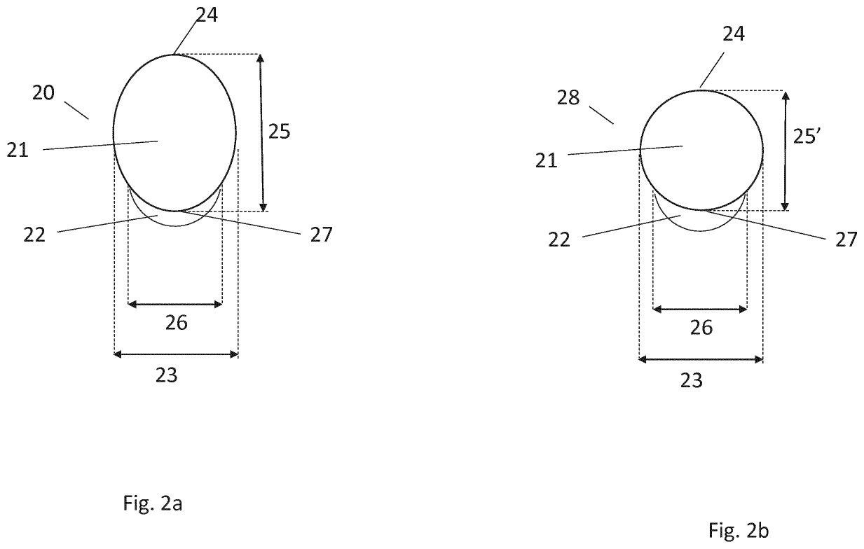

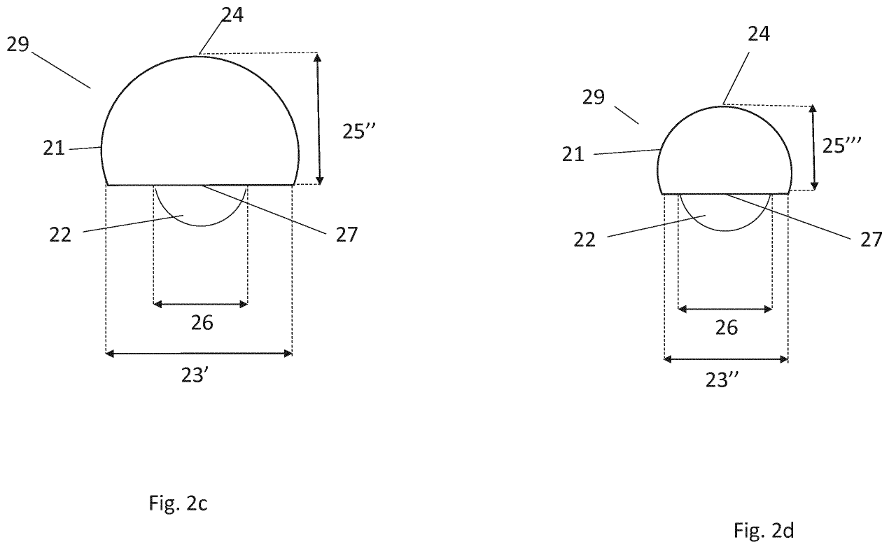

FIG. 2 shows examples of different shapes of obstructions.

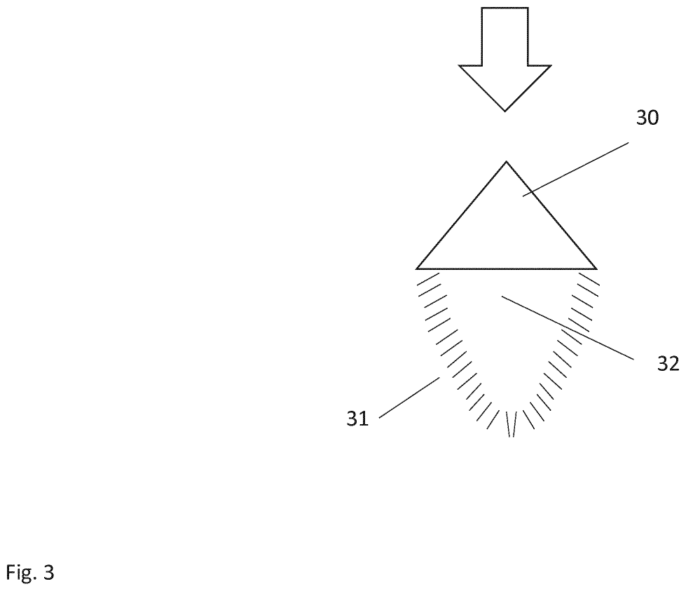

FIG. 3 illustrates an example of an obstruction with a barrier section for use in a fluid refining device

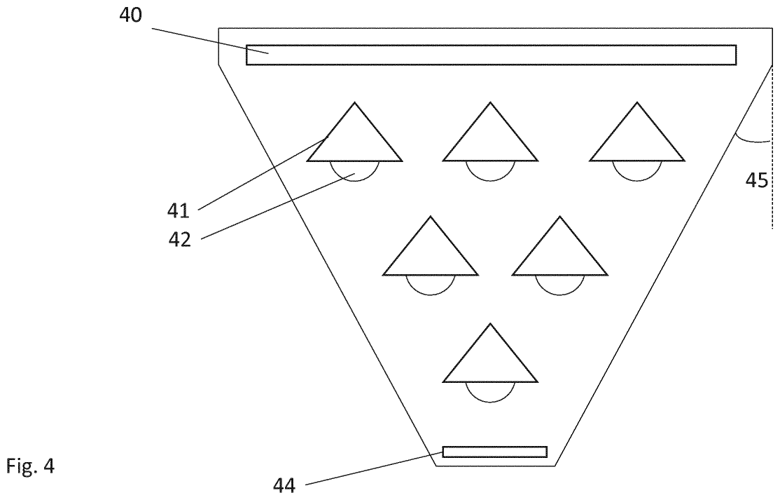

FIG. 4 illustrates an example of a channel layout of a fluid refining device.

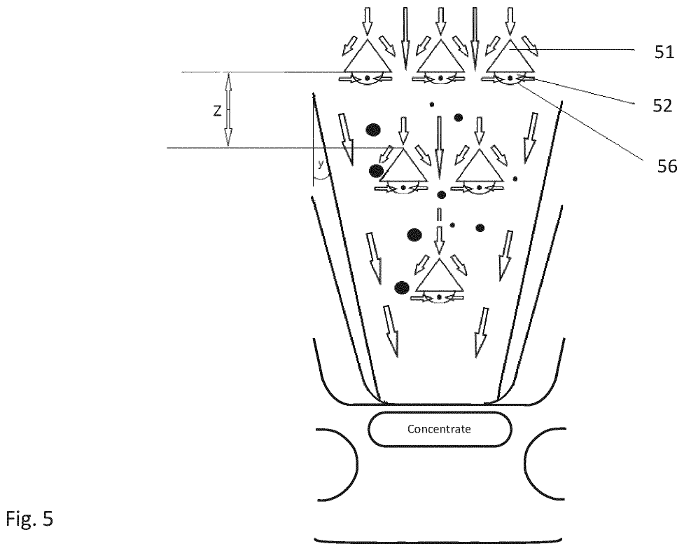

FIG. 5 illustrates the particle and fluid flow for an exemplary embodiment of a fluid refining device.

FIG. 1 illustrates an example of a triangular obstruction head 10 which may be used in a fluid refining device. The obstruction 10 comprises a obstruction head 11 and is adapted to be facing with a front vertex 14 in an upstream direction towards an incoming fluid and a base edge 17 opposite of the front vertex. A fluid outlet 12 is arranged at the base edge. FIG. 1a and FIG. 1b shows two embodiments with different size of the fluid outlet 12, having diameters 16, and 16′, respectively.

FIG. 2 shows examples of different shapes of obstructions. In FIG. 2a, the obstruction 20 is oval shaped (oval shaped head), while the obstruction 28 in FIG. 2b is circular. FIGS. 2c and 2d shows different sized semi-circle shaped obstructions 29. The obstructions 20, 28, 29 are adapted to be facing with a front vertex 24 in an upstream direction towards an incoming fluid and a have a base edge 27 opposite of the front vertex. A fluid outlet 22 is arranged at the base edge. The fluid outlets 22 have the same diameters 26 and the width 23 are the same for obstructions 20 and 28, while the and length 25, 25′ of the obstructions 20, 28 are different. The obstructions 29 of FIGS. 2c and 2d have different length and width, 25″, 25″′, 23′, 23″. Other shapes and sizes of obstructions are also possible, for example bell shaped, trapezoid shaped, etc.

FIG. 3 illustrates an example of an obstruction 30 with a barrier section 31 for use in a fluid refining device. The obstruction 30 with barrier section 31 is adapted to be arranged in a fluid flowing in the direction of the arrow. The barrier section 31 is adapted to be facing in a downstream direction and comprise a series of barrier elements and interposed gaps. The barrier elements may have a turbine blade-like shape and the interposed gaps define barrier channels providing fluid communication between the incoming fluid and the fluid outlet 32.

An example of a channel layout of a fluid refining device is presented in FIG. 4 and is comprised of a feed fluid inlet 40, a number of obstructions 41, filtrate outlets 42, and a concentrate outlet for collection of large particles and cells 44. The obstructions 41 are in this embodiment the type illustrated in FIG. 1 and are arranged to be facing with their front vertex in an upstream direction towards the incoming fluid and a base edge opposite of the front, and a fluid outlet arranged at the base edge.

In the following, we use the term particles as a general term that comprises all kinds of particles, including cells and other bioparticles. The channel contraction angle is shown as 45 and represents a decrease in flow cross section experienced by the flowing fluid entering at inlet 41 and exiting at outlet 44. The angle 45 can vary and will preferably be adapted to the specific use of the device. The angle may for example be adapted to the number of obstructions 41 and fluid outlets 42 arranged on the device as well as the amount of fluid flowing through the device. Fewer obstructions, and thus fewer fluid outlets means that less fluid is filtrated out before reaching the outlet 44, and thus the angle 45 should be smaller in order to maintain substantially continuous flow over the device.

FIG. 5 illustrates the principle used by the invention for separation and concentration of a fluid flowing through a fluid refining device. An incoming feed flow with cell/particles of various properties, such as size, deformability and shape, is split in a concentrate flow and a filtrate flow by means of a number of filtrate units arranged in a fluid refining device, for example as shown in FIG. 4. The filtrate units comprise obstructions 51 and filter outlets 52. The fluid flows along the path illustrated by the arrows, thus removing fluid through filtrate outlets 52 downstream of obstructions 51. These obstructions are shaped like triangles in FIG. 5, but as discussed above, they can have any shape. The combination of the suction flow through the filter outlets 52 and the incoming feed flow creates a saddle point of converging flow streamlines 56, which in FIG. 5 is positioned directly downstream of the filter outlet. Since the flow must go around the obstructions 51, a flow layer form around the obstruction. The thickness of the flow layer is determined by the fluid characteristics, such as viscosity, flow velocity etc. Particles inside this layer generally follow the flow passively and thus end up in the filtrate outlet, while particles which are larger, heavier, have different deformability etc. will not be captured by the flow layer and can be separated from the fluid and simultaneously concentrated.

There are two reasons why separation is possible. First, a particle with center-of-mass outside the flow layer gets associated with streamlines in the bulk and is therefore carried downstream with this flow. This method used for size-based separation is illustrated in FIG. 5. However, the size of the particle does not have to be larger than the extent of flow layer to achieve concentration. Instead, the inertia associated with the particle, which is resulting from the interactions with obstructions and flow field, can be utilized to generate an additional mass, called “virtual mass”, which increases the virtual size of the particle (sometimes called hydrodynamic diameter). Thus, the applicability of the geometry is not restricted to size-based separation and concentration but includes e.g. deformation-based and density based separation. Owing to the continuous dewatering of filtrate fluid through each filter outlet, particles with large virtual of physical diameters are simultaneously concentrated while they are separated from their smaller counterparts. Finally, to ensure that the velocities required for precise particle manipulation are maintained downstream, the channel continuously decreases with downstream distance, as indicated by the angle y.

1. Fluid refining device, comprising at least two obstructions adapted to be facing with a front in an upstream direction towards an incoming fluid and a base edge opposite of the front, and a fluid outlet arranged at the base edge.

2. Fluid refining device according to claim 1, where the obstructions are triangularly shaped heads, and the heads are adapted to be arranged with a front vertex facing the upstream direction and the base edge is the edge of the triangular shape which is opposite of the front vertex.

3. Fluid refining device according to claim 1, where the obstructions are bell shaped.

4. Fluid refining device according to claim 1, further comprising a barrier section facing in a downstream direction, the barrier section comprising a series of barrier elements and interposed gaps, where the barrier elements have a turbine blade-like shape and the interposed gaps define barrier channels providing fluid communication between the incoming fluid and the fluid outlet.

5. Fluid refining device according to one of the previous claims, comprising pressure sensors, for example arranged at the fluid inlet and/or the fluid outlet and/or other locations along the fluid flow path for measuring the fluid pressure.

6. Fluid refining device according to any one of claims 1-4, comprising pressure control devices at the fluid inlet and/or the fluid outlet.

7. Fluid refining device according to any one of claims 1-4, comprising or being connected to a processor adapted to control the fluid pressure at the inlet and/or the outlet and/or at the locations of the obstructions.
